(19) United States
(12) Patent Application Publication
(10) Pub. No.: US 2010/0284353 A1
(43) Pub. Date: Nov. 11, 2010

(54) METHOD AND SYSTEM FOR MANAGING TRANSMISSION RESOURCES IN A WIRELESS COMMUNICATIONS SYSTEM

(75) Inventors: Gang Wu, Shanghai (CN); Ni Ma, Shanghai (CN); Xiaobo Zhang, Shanghai (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/682,102

(22) PCT Filed: Oct. 10, 2008
(86) PCT No.: PCT/IB08/54183

§ 371 Date: Jul. 1, 2010

(30) Foreign Application Priority Data
Oct. 12, 2007 (CN) 200710181177.6
Oct. 10, 2008 (IB) PCT/IB2008/054183

(51) Int. Cl. H04W 72/04

(52) U.S. Cl. 370/329

(57) ABSTRACT

A technique for managing the transmission resources in a wireless communications system (100) that includes a base station (102) and a plurality of mobile stations (104), wherein the base station is configured to transmit baseband signals from at least two antennas (106), involves identifying resource blocks that are available for baseband transmissions, identifying antennas (106) of the base station (102) that are available for baseband transmissions, and establishing a transmission scheme for the plurality of mobile stations (104) that defines both the allocation of available resource blocks and the selection of available antennas (106) amongst the plurality of mobile stations (104).

The invention relates generally to wireless communications systems, and more particularly, to establishing a transmission scheme in a multi-user environment.

The 3rd Generation Partnership Project (3GPP) was established to produce globally applicable technical specifications and technical reports for a 3rd generation mobile system based on evolved Global System for Mobile communications (GSM) core networks and the radio access technologies that they support (i.e., Universal Terrestrial Radio Access (UTRA) in both Frequency Division Duplex (FDD) and Time Division Duplex (TDD) modes). The scope was subsequently amended to include the maintenance and development of the GSM technical specifications and technical reports including evolved radio access technologies (e.g., General Packet Radio Service (GPRS) and Enhanced Data rates for GSM Evolution (EDGE)).

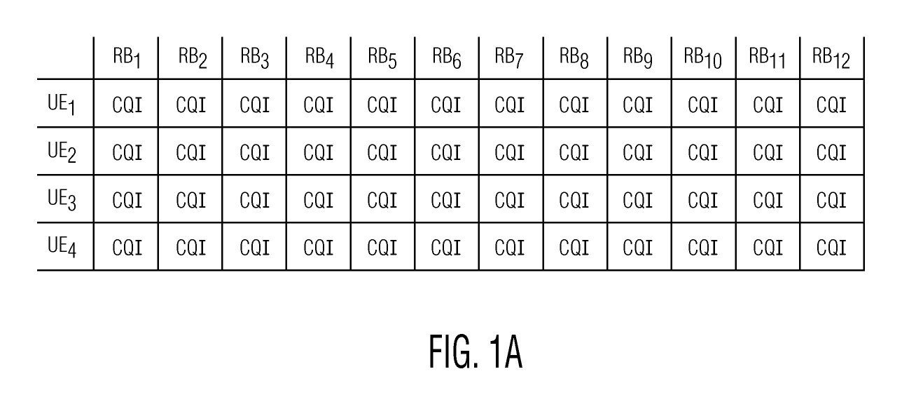

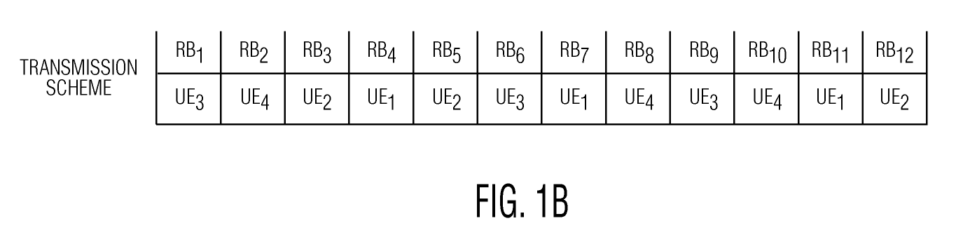

In 3GPP Long Term Evolution (LTE) wireless communications systems that utilize frequency domain duplexing (FDD), resource blocks (e.g., frequency based resource blocks) are typically allocated according to channel quality information that is provided in the form of channel quality indicators (CQI). FIG. 1A illustrates exemplary channel quality information for a wireless communications system with twelve resource blocks and four mobile stations, referred to herein as User Equipments (UEs). In particular, FIG. 1A illustrates a CQI for each UE at each resource block. According to conventional techniques, the CQIs are compared on a per-resource block basis and the resource blocks are allocated to the UEs based on the relative magnitude of the CQIs. For example, the UE exhibiting the highest CQI within a particular resource block is allocated the resource block. Following this approach, each resource block is allocated to a single UE until all of the resource blocks have been allocated. The resulting transmission scheme defines the allocation of the resource blocks amongst the UEs. FIG. 1B illustrates an example of a transmission scheme that results from the allocation of the resource blocks from FIG. 1A. As illustrated in FIG. 1B, resource block, RB1, is allocated to UE3, resource block, RB2, is allocated to UE4, and so on. In 3GPP LTE TDD systems, the resource allocation for the UEs is based on channel response values calculated directly from the uplink sounding signal.

In addition to frequency diversity and/or time diversity, multiple antenna transceivers enable spatial diversity. For example, a base station with multiple antennas can communicate with UEs using space-time transmit diversity (STTD). STTD is useful in dealing with the problem of time-varying multipath fading. While STTD helps to deal with time-varying multipath fading, conventional transmission schemes define the allocation of resource blocks among a set of UEs without considering spatial diversity.

A technique, in accordance with an embodiment of the invention, for managing the transmission resources in a wireless communications system that includes a base station and a plurality of mobile stations, wherein the base station is configured to transmit baseband signals from at least two antennas, involves identifying resource blocks that are available for baseband transmissions, identifying antennas of the base station that are available for baseband transmissions, and establishing a transmission scheme for the plurality of mobile stations that defines both the allocation of available resource blocks and the selection of available antennas amongst the plurality of mobile stations. This technique takes into consideration both spatial diversity and frequency and/or time diversity when establishing a transmission scheme. Taking both spatial diversity and frequency/time diversity into consideration when establishing a transmission scheme enables the available antennas and resource blocks to be used in a manner that optimizes the performance of the entire wireless communications system.

Other aspects and advantages of the present invention will become apparent from the following detailed description, taken in conjunction with the accompanying drawings, illustrating by way of example the principles of the invention.

FIG. 1A illustrates exemplary channel quality information for a wireless communications system with twelve resource blocks and four UEs.

FIG. 1B illustrates an example of a transmission scheme that results from the allocation of the resource blocks from FIG. 1A.

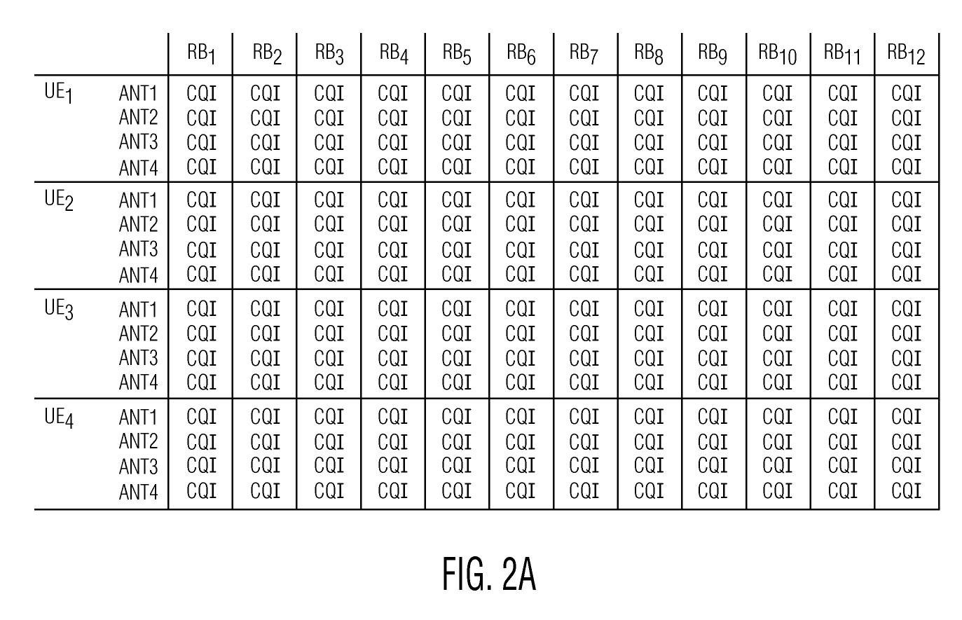

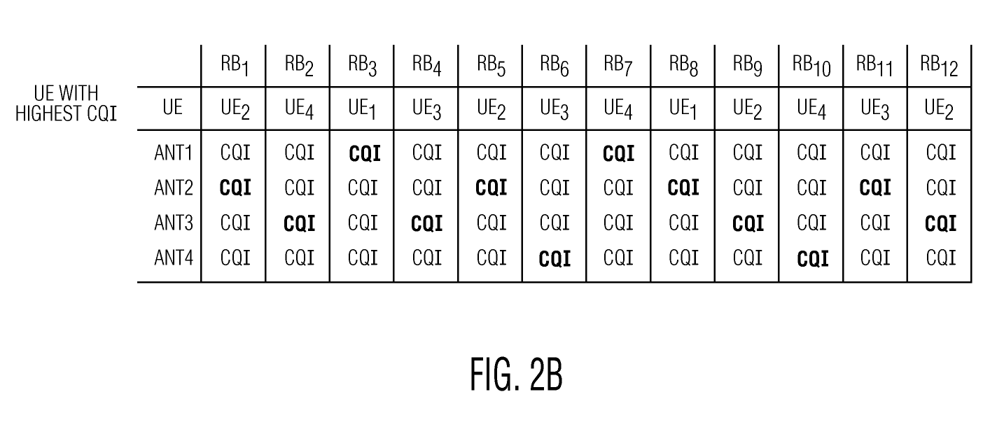

FIGS. 2A-2C depict matrices of channel information that illustrate a technique for establishing a transmission scheme using a complete set of channel quality information to allocate resource blocks and select antennas.

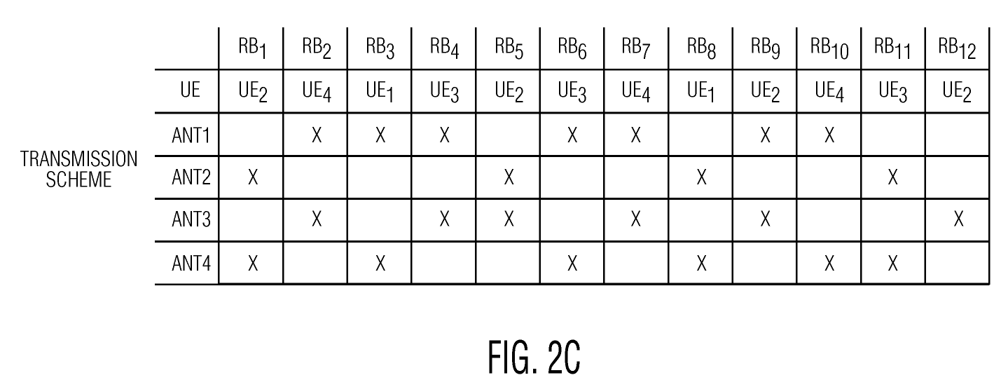

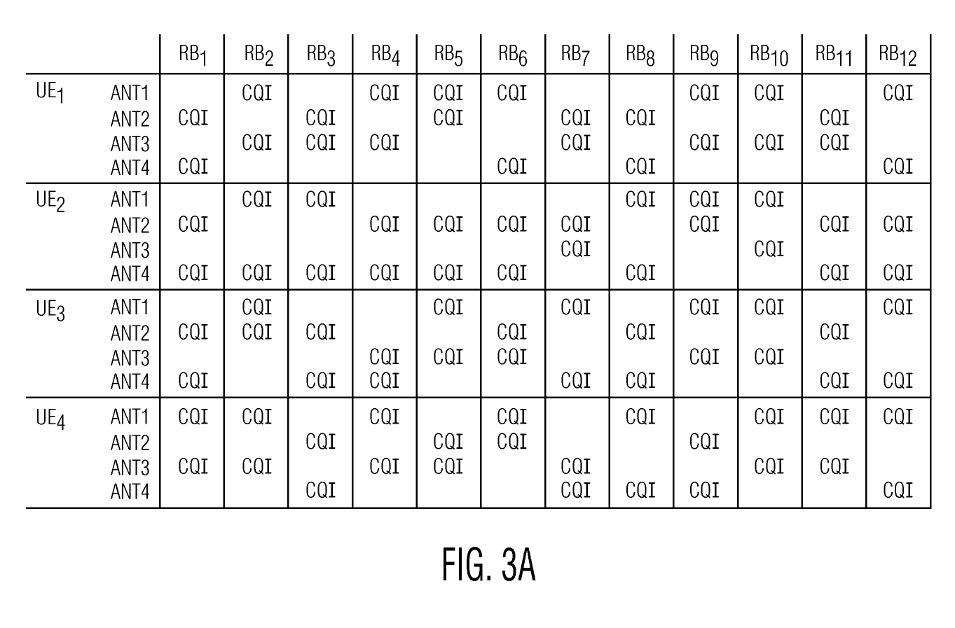

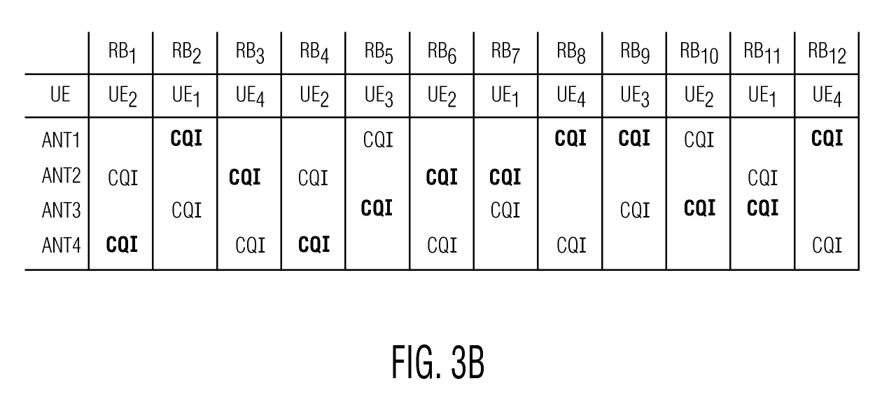

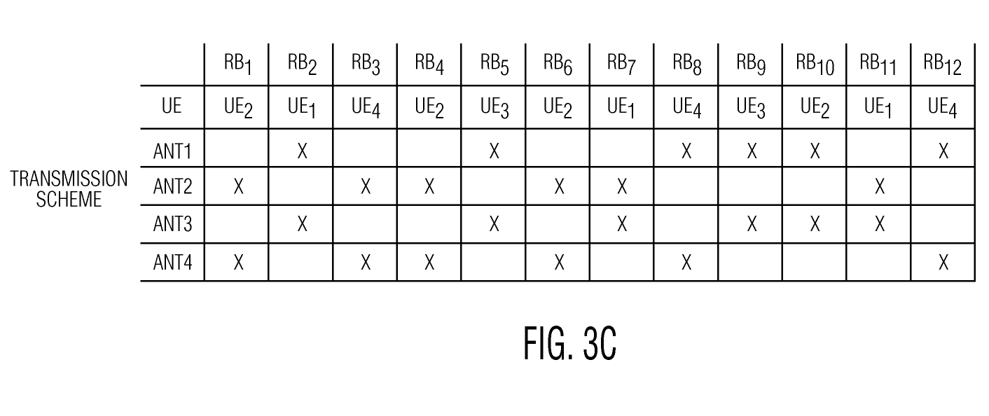

FIGS. 3A-3C depict matrices of channel information that illustrate a technique for establishing a transmission scheme using a limited set of channel quality information to allocate resource blocks and select antennas.

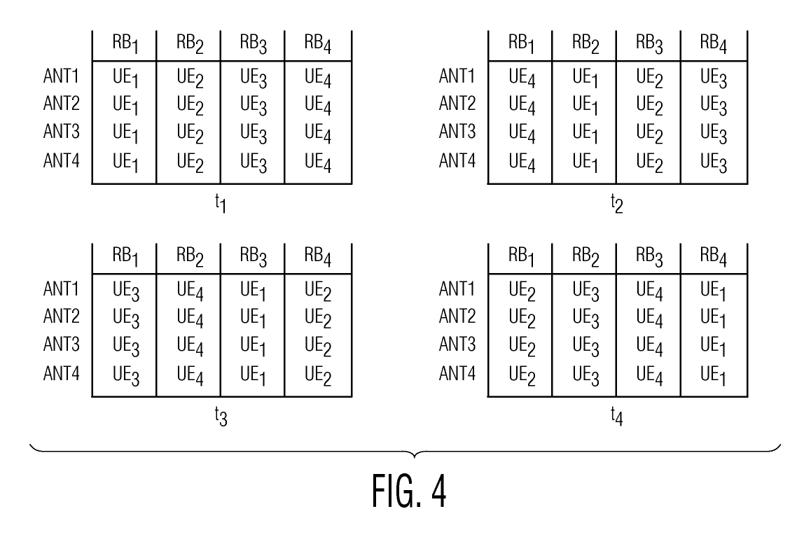

FIG. 4 depicts the allocation of resources blocks at different time intervals to illustrate a technique for establishing a transmission scheme that involves sequentially changing resource blocks amongst UEs over multiple time intervals.

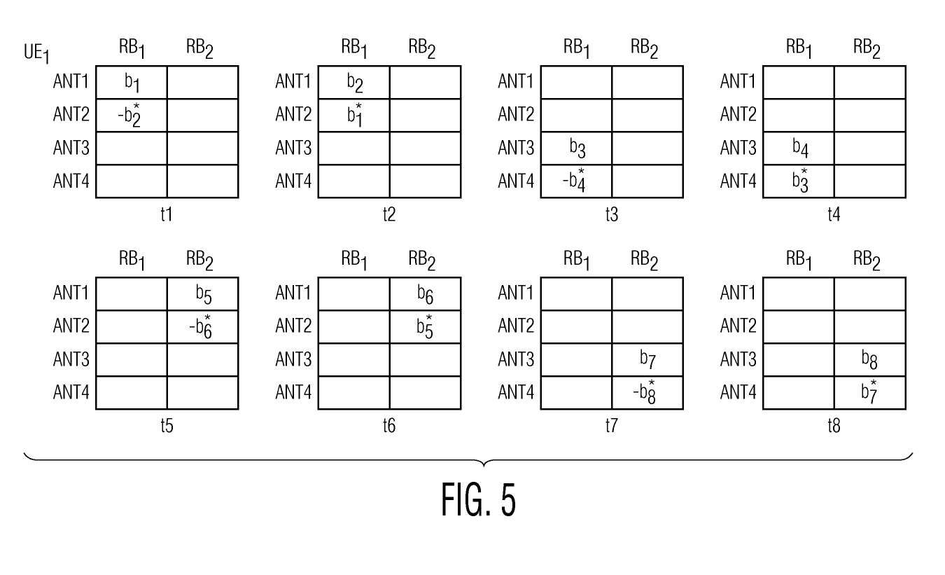

FIG. 5 depicts the sequential switching of resource blocks and antennas for a single UE in a wireless communications system in which the base station has four antennas and there are two available resource blocks.

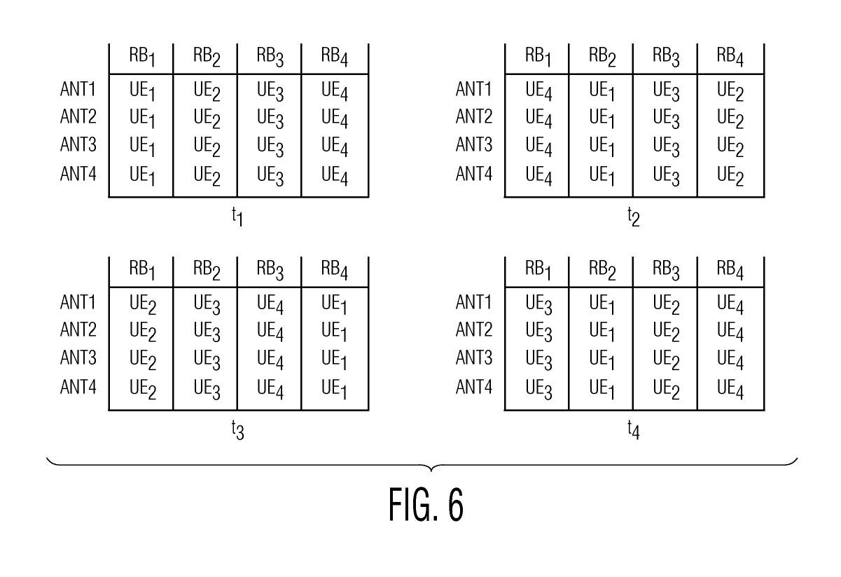

FIG. 6 depicts the allocation of resources blocks at different time intervals to illustrate a technique for establishing a transmission scheme that involves randomly changing resource blocks amongst UEs over multiple time intervals.

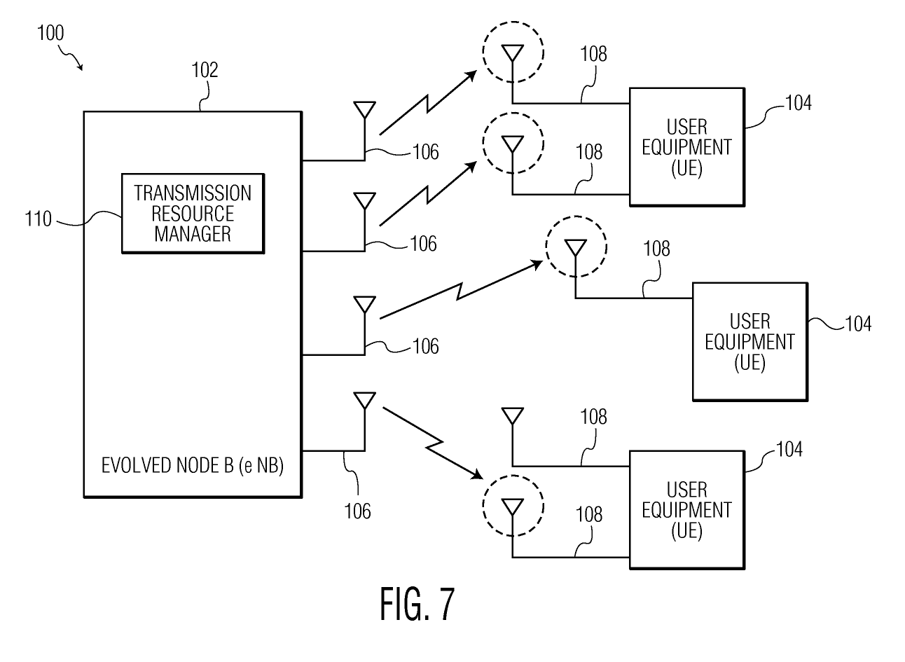

FIG. 7 depicts a wireless communications system that includes multiple mobile stations and a base station that is configured to manage transmission resource in accordance with an embodiment of the invention.

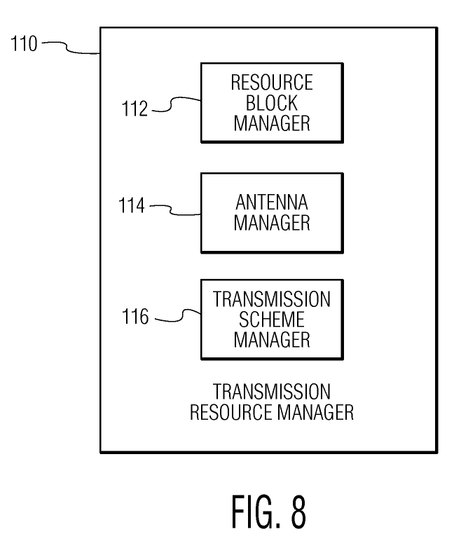

FIG. 8 depicts a functional block diagram of an embodiment of a transmission resource manager that includes a resource block manager, an antenna manager, and a transmission scheme manager.

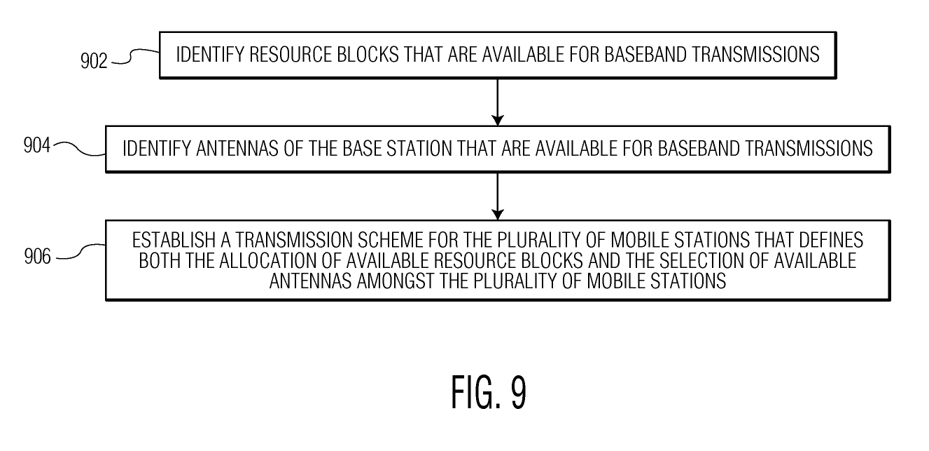

FIG. 9 is a process flow diagram of a method for managing transmission resources in accordance with an embodiment of the invention.

Throughout the description, similar reference numbers may be used to identify similar elements.

A technique, in accordance with an embodiment of the invention, for establishing a transmission scheme involves using channel quality information to allocate resource blocks and select antennas. This technique is especially applicable to a situation where sufficient channel quality information is available to a base station. A first embodiment of the technique is especially applicable to a situation in which channel quality information, e.g., in the form of CQIs, is available to a base station for each UE on a per-resource block and a per-antenna basis. A second embodiment of the technique is especially applicable to a situation in which a complete set of CQIs is not available to a base station, e.g., in the case where the UEs feed selected CQIs to the base station. An example of the first embodiment is described with reference to FIGS. 2A-2C and an example of the second embodiment is described with reference to FIGS. 3A-3C.

According to the first embodiment, channel quality information in the form of CQIs is collected for each UE on a per-resource block and a per-antenna basis. FIG. 2A is a matrix of collected CQIs for each UE on a per-resource block and per-antenna basis in a wireless communications system that includes a base station with four antennas, four UEs, and twelve available resource blocks. Once the CQIs are collected for each UE on a per-resource block and a per-antenna basis, the resource blocks are allocated to the UEs. In an embodiment, each resource block is allocated to the UE with the highest CQI in the corresponding resource block. For example, the CQI for each UE in resource block, RB1, is evaluated relative to the other CQIs in the resource block and the resource block is allocated to the UE with the highest CQI. The process of evaluating CQIs on a per-resource block basis is performed for each resource block. FIG. 2B is a matrix that indicates the UE to which each resource block has been allocated. The highest CQI of the corresponding UE is indicated in bold.

Once the resource blocks are allocated to the UEs, antennas are selected for each resource block. For example, two antennas are selected for each resource block. In an embodiment, one of the selected antennas corresponds to the highest CQI of the resource block as indicated in bold in FIG. 2B. The other antenna may be selected based on channel quality information or some other criteria. In an embodiment, the antenna with the next highest CQI is selected as the other antenna and in another embodiment, the other antenna is selected to optimize spatial diversity, e.g., to select the two most spatially diverse antennas.

Once the antennas are selected for each resource block, the transmission scheme is established. The resulting transmission scheme defines both the allocation of available resource blocks and the selection of available antennas amongst the UEs. FIG. 2C is a matrix that identifies the transmission scheme that is established in response to the CQIs that are described with reference to FIGS. 2A and 2B. The matrix of FIG. 2C indicates both the allocation of resource blocks and the selection of antennas amongst the UEs for the entire pool of available transmission resources.

According to the second embodiment, a complete set of CQIs is not available for use in establishing the transmission scheme. This embodiment is especially applicable to the situation where the UEs feed channel quality information of selected antennas back to the base station, e.g., in the form of CQIs. FIG. 3A is a matrix of CQIs for each UE on a per-resource block and a per-antenna basis in the case where a complete set of CQIs is not available. As with the example of FIG. 2A, the wireless communications system includes a base station with four antennas, four UEs, and twelve available resource blocks.

Once all of the available CQIs are collected for the UEs on a per-resource block and a per-antenna basis, the resource blocks are allocated to the UEs. In an embodiment, each resource block is allocated to the UE with the highest CQI in the corresponding resource block. For example, the CQI for each UE in resource block, RB1, is evaluated relative to the other CQIs in the resource block and the resource block is allocated to the UE with the highest CQI. The process of evaluating CQIs on a per-resource block basis is performed for each resource block.

FIG. 3B is a matrix that indicates the UE to which each resource block has been allocated. Additionally, the highest CQI of the corresponding UE is indicated in bold. Once the resource blocks are allocated to the UEs, antennas are selected for each resource block. For example, two antennas are selected for each resource block. In an embodiment, one of the selected antennas is the antenna that corresponds to the highest CQI of the resource block as indicated in bold in FIG. 3B. In an embodiment, the other antenna is selected from the antennas that have a corresponding CQI, e.g., the antenna with the next highest CQI. Among the antennas that have a CQI, the other antenna may be selected based on CQI or some other criteria. In another embodiment, the other antenna is selected based on some other criteria. For example, the other antenna is selected to optimize spatial diversity, e.g., to select the two most spatially diverse antennas. In an alternative embodiment, the other antenna may be one of the antennas for which channel quality information is not available.

Once the antennas are selected for each resource block, the resulting transmission scheme defines both the allocation of available resource blocks and the selection of available antennas amongst the UEs. FIG. 3C is a matrix that identifies the transmission scheme that is established in response to the CQIs that are described with reference to FIGS. 3A and 3B. The matrix indicates both the allocation of resource blocks and the selection of antennas amongst the UEs for the entire pool of available transmission resources.

A second technique for establishing a transmission scheme involves changing resource block allocation and antenna selection amongst the multiple UEs on a periodic basis. This technique is especially applicable when the techniques that rely on channel quality information cannot be used, for example, because insufficient channel quality information is available. According to one embodiment, resource block allocation and antenna selection is changed amongst the multiple UEs in a sequential manner and according to another embodiment, resource block allocation and antenna selection is changed amongst the multiple UEs in a random manner.

In sequential changing, resource block allocation and antenna selection is sequentially switched or rotated amongst the UEs. For example, the resource block allocation for each UE is sequentially changed amongst all of the resource blocks. FIG. 4 depicts the sequential changing of resource blocks amongst four UEs over four time intervals (t1-t4). As depicted in FIG. 4, at time t1, RB1 is allocated to UE1, RB2 is allocated to UE2, RB3 is allocated to UE3, and RB4 is allocated to UE4. At time t2, resource block allocation is sequentially changed such that RB1 is allocated to UE4, RB2 is allocated to UE1, RB3 is allocated to UE2, and RB4 is allocated to UE3. At time t3, resource block allocation is sequentially changed such that RB1 is allocated to UE3, RB2 is allocated to UE4, RB3 is allocated to UE1, and RB4 is allocated to UE2. At time t4, resource block allocation is sequentially changed such that RB1 is allocated to UE2, RB2 is allocated to UE3, RB3 is allocated to UE4, and RB4 is allocated to UE1. A similar sequential changing of resource blocks is followed for subsequent time periods. The selection of antennas within each resource block can be sequentially changed simultaneous with the changing of the resource block allocations, for example, as described below with reference to FIG. 5.

FIG. 5 depicts the sequential changing of resource blocks and antennas for a single UE in a wireless communications system in which the base station has four antennas and there are two available resource blocks. At times t1 and t2, symbols are transmitted using resource block, RB1, and antennas 1 and 2. At times t3 and t4, the transmitting antennas are sequentially changed to antennas 3 and 4 while resource block, RB1, continues to be used. At times t5 and t6, the transmitting resource block is sequentially changed to resource block, RB2, and the transmitting antennas are sequentially changed to antennas 1 and 2. At times t7 and t8, the transmitting antennas are switched to antennas 3 and 4 while resource block, RB2, continues to be used. As shown in FIG. 5, both the resource block allocation and the antenna selection are sequentially changed between the available resource blocks and the available antennas on a periodic basis.

As an alternative to the sequential changing described above with reference to FIGS. 4 and 5, resource block allocation and antenna selection can be randomly changed or hopped between different resource blocks and antennas. FIG. 6 depicts the random changing of resource blocks amongst four UEs over four time intervals (t1-t4). As depicted in FIG. 4, at time t1, RB1 is allocated to UE1, RB2 is allocated to UE2, RB3 is allocated to UE3, and RB4 is allocated to UE4. At time t2, resource block allocation is randomly changed such that RB1 is allocated to UE4, RB2 is allocated to UE1, RB3 is allocated to UE3, and RB4 is allocated to UE2. At time t3, resource block allocation is randomly changed such that RB1 is allocated to UE2, RB2 is allocated to UE3, RB3 is allocated to UE4, and RB4 is allocated to UE1. At time t4, resource block allocation is randomly changed such that RB1 is allocated to UE3, RB2 is allocated to UE1, RB3 is allocated to UE2, and RB4 is allocated to UE4. A random changing of resource blocks is followed for subsequent time periods. The selection of antennas within each resource block can be randomly changed simultaneous with the changing of the resource block allocations, for example, as described below with reference to FIG. 5.

As another alternative, resource block allocation and antenna selection can be changed using a combination of sequential and random changes. For example, resource block allocation can be changed sequentially while antenna selection is changed randomly or resource block allocation can be changed randomly while antenna selection is changed sequentially. As another alternative, resource block allocation can be changed in a partially sequential manner and a partially random manner. Likewise, antenna selection can be changed in a partially sequential manner and a partially random manner.

FIG. 7 depicts a wireless communications system 100 that includes a base station 102 (referred to herein as an evolved Node B (eNB)) and multiple mobile stations 104 (referred to herein as UEs). The wireless communications system can be operated in multi-user multiple-input multiple-output (MU-MIMO) mode. In the embodiment of FIG. 7, the eNB is a wireless communications base station that supports MU-MIMO operation as specified in the 3GPP LTE specification, including STTD. The eNB includes four antennas 106 although the eNB can include more than four antennas. In the embodiment of FIG. 7, the UEs are wireless communications mobile stations that support wireless operation as specified in the 3GPP LTE specification. The UEs may have one or two antennas 108, although the UEs are not limited to two antennas (e.g., the UEs can include more than two antennas).

The base station (eNB) 102 includes a transmission resource manager 110 that is responsible for managing the transmission resources as described above with reference to FIGS. 2A-6. FIG. 8 depicts a functional block diagram of an embodiment of the transmission resource manager that includes a resource block manager 112, an antenna manager 114, and a transmission scheme manager 116. The resource block manager is responsible for identifying resource blocks that are available for baseband transmission, the antenna manager is responsible for identifying antennas of the base station that are available for baseband transmissions, and the transmission scheme manager is responsible for establishing a transmission scheme for the mobile stations that defines both the allocation of available resource blocks and the selection of available antennas amongst the mobile stations.

FIG. 9 is a process flow diagram of a method for managing transmission resources in a wireless communications system that includes a base station and multiple mobile stations, wherein the base station is configured to transmit baseband signals from at least two antennas. At block 902, resource blocks that are available for baseband transmissions are identified. At block 904, antennas of the base station that are available for baseband transmissions are identified. At block 906, a transmission scheme is established for the mobile stations that defines both the allocation of available resource blocks and the selection of available antennas amongst the mobile stations.

In an embodiment, in FDD systems, channel quality information is obtained from CQI values that are sent by the UEs to the base station. In TDD systems, uplink channel quality information is estimated from uplink sounding signals and the uplink channel estimations are used as channel quality information for the downlink channels because of channel reciprocity in TDD systems.

Although CQIs are described as one form of channel quality information, other forms of channel quality information can be used in establishing a transmission scheme. Resource blocks may refer to frequency blocks in the frequency domain and/or time blocks in the time domain. Although the above-described techniques are described in the context of 3GPP LTE wireless communications systems, the techniques are also applicable to other types of wireless communications systems such as, for example, WiMAX.

Although specific embodiments of the invention have been described and illustrated, the invention is not to be limited to the specific forms or arrangements of parts as described and illustrated herein. The invention is limited only by the claims.

What is claimed is:

1. A method for managing the transmission resources in a wireless communications system that includes a base station and a plurality of mobile stations, wherein the base station is configured to transmit baseband signals from at least two antennas, the method comprising:
identifying resource blocks that are available for baseband transmissions;
identifying antennas of the base station that are available for baseband transmissions; and
establishing a transmission scheme for the plurality of mobile stations that defines both the allocation of available resource blocks and the selection of available antennas amongst the plurality of mobile stations.

2. The method of claim 1 wherein establishing a transmission scheme comprises allocating resource blocks and selecting antennas in response to an evaluation of channel quality information on a per-resource block and per-antenna basis amongst all of the mobile stations.

3. The method of claim 1 further comprising allocating resource blocks to mobile stations exhibiting the highest channel quality as indicated by the channel quality information.

4. The method of claim 3 further comprising, amongst the allocated resource blocks, selecting antennas for the mobile stations exhibiting the highest channel quality as indicated by the channel quality information.

5. The method of claim 1 further comprising allocating resource blocks on a per-antenna basis to mobile stations exhibiting the highest channel quality as indicated by the channel quality information.

6. The method of claim 1 further comprising obtaining channel quality information on a per-antenna and a per-resource block basis for each mobile station.

7. The method of claim 1 wherein establishing a transmission scheme comprises changing both the resource block allocation and the antenna section on a periodic basis.

8. The method of claim 1 wherein the establishing a transmission scheme comprises sequentially changing both resource block allocation and antenna selection amongst the plurality of mobile stations on a periodic basis.

9. The method of claim 1 wherein establishing a transmission scheme comprises randomly changing both resource block allocation and antenna selection amongst the plurality of mobile stations on a periodic basis.

10. The method of claim 1 wherein establishing a transmission scheme comprises evaluating a pool of transmission resources that exists among the plurality of mobile stations and establishing a transmission protocol for the mobile stations in response to the evaluation of the pool of transmission resources.

11. A system for managing the transmission resources in a wireless communications system that includes a base station and a plurality of mobile stations, wherein the base station is configured to transmit baseband signals from at least two antennas, the system comprising:
a resource block manager configured to identify resource blocks that are available for baseband transmissions;
an antenna manager configured to identify antennas of the base station that are available for baseband transmissions; and
a transmission scheme manager configured to establish a transmission scheme for the plurality of mobile stations that defines both the allocation of available resource blocks and the selection of available antennas amongst the plurality of mobile stations.

12. The system of claim 11 wherein establishing a transmission scheme comprises allocating resource blocks and selecting antennas in response to an evaluation of channel quality information on a per-resource block and per-antenna basis amongst all of the mobile stations.

13. The system of claim 11 further comprising allocating resource blocks to mobile stations exhibiting the highest channel quality as indicated by the channel quality information.

14. The system of claim 13 further comprising, amongst the allocated resource blocks, selecting antennas for the mobile stations exhibiting the highest channel quality as indicated by the channel quality information.

15. The system of claim 11 further comprising allocating resource blocks on a per-antenna basis to mobile stations exhibiting the highest channel quality as indicated by the channel quality information.

16. The system of claim 11 wherein establishing a transmission scheme comprises changing both the resource block allocation and the antenna section on a periodic basis.

17. The system of claim 11 wherein the establishing a transmission scheme comprises sequentially changing both resource block allocation and antenna selection amongst the plurality of mobile stations on a periodic basis.

18. The system of claim 11 wherein establishing a transmission scheme comprises randomly changing both resource block allocation and antenna selection amongst the plurality of mobile stations on a periodic basis.

19. The system of claim 11 wherein establishing a transmission scheme comprises evaluating a pool of transmission resources that exists among the plurality of mobile stations and establishing a transmission protocol for the mobile stations in response to the evaluation of the pool of transmission resources.

20. A method for managing the transmission resources in a wireless communications system that includes multiple mobile stations and a base station that is capable of space time transmission diversity (STTD), the method comprising:
identifying a pool of transmission resources that exists for transmission to the plurality of mobile stations, wherein the pool of transmission resources includes multiple base station antennas and multiple resource blocks;
evaluating the pool of transmission resources; and
establishing a transmission protocol for the mobile stations in response to the evaluation of the pool of transmission resources.
